(19) United States
(12) Patent Application Publication
(10) Pub. No.: US 2023/0261360 A1
(43) Pub. Date: Aug. 17, 2023

(54) RADAR APPARATUS COMPRISING MULTIPLE ANTENNAS

(71) Applicant: WISENSE TECHNOLOGIES LTD., Tel Aviv (IL)

(72) Inventors: Moshik Moshe COHEN, Or Yehuda (IL); Yekutiel AVARGEL, Nir Galim (IL)

(73) Assignee: WISENSE TECHNOLOGIES LTD., Tel Aviv (IL)

(21) Appl. No.: 17/920,821

(22) PCT Filed: Apr. 22, 2021
(86) PCT No.: PCT/IL2021/050458

§ 371 Date: Oct. 24, 2022

Related U.S. Application Data
Application No. PCT/IL2021/050458 is a continuation of application No. 16/854,940, filed on Apr. 22, 2020, now abandoned.

(51) Int. Cl. H01Q 1/22; H01Q 21/28; G01S 7/03; H01Q 21/06

(52) U.S. Cl. CPC H01Q 1/2283; G01S 7/032; H01Q 21/28; H01Q 21/061

(57) ABSTRACT

An apparatus comprising a first antenna array and a second antenna array, each antenna array comprising a set of antennas, wherein for both antenna arrays, the positions of each two adjacent antennas are different in relation to a first axis and in relation to a second axis, perpendicular to the first axis.

### FIELD OF THE INVENTION

The present invention relates generally to radars. More specifically, the present invention relates to a radar apparatus comprising multiple antennas.

### BACKGROUND OF THE INVENTION

The use of radar systems is commonplace in modern applications of spatial navigation and location, such as in the emerging discipline of automated vehicles. Such systems are commonly required to provide high-end performance, to produce superior output signals for further analysis and manipulation.

The design of modern radar systems is required to be compact in size, so as to comply with physical and cost-related constraints. In addition, modern radar systems are required to be easily and reproducibly manufactured. For example, radar systems should be manufactured in a manner that would provide reproducible results between different instances of radar and/or elements thereof (e.g., antennas, transmitters, receivers and the like).

Phased-array based radars have been introduced in modern radar systems and applications to accommodate the above constraints. Such radars include an array of antennas that may transmit a beam of radio-frequency (RF) energy and receive a reflection or echo of the RF energy from surrounding objects. The RF beam may be electronically steered to point in different directions without moving the antennas, thus contributing to the simplicity of manufacture and installment of the radar system.

Modern radar systems may include an array of multiple reception (RX) antennas and an array of multiple transmission (TX) antennas. Such radar systems may include, for example, multiple input multiple output (MIMO) radar systems. As known in the art, MIMO radar systems may provide an advancement over conventional phased-array radar systems. In such systems, transmitted signals from the plurality of transmission antennas may be distinguishably different. As a result, the echo signals can be re-assigned to the source, thus providing an enlarged virtual receive aperture and a superior spatial resolution. In traditional phased-array systems, additional antennas and related hardware are needed to improve spatial resolution. MIMO radar systems transmit mutually orthogonal signals from multiple transmit antennas, and these waveforms can be extracted from each of the receive antennas by a set of matched filters. For example, in a MIMO radar system that has 3 TX antennas and 4 RX antennas, an overall number of 12 signals can be extracted from the receiver because of the orthogonality of the transmitted signals. Therefore, in this example, a 12-element virtual MIMO array is created using only 7 antennas by conducting digital signal processing on the received signals.

As known in the art, commercially available multiple antenna radar systems, such as MIMO radar systems include a wide variety of configurations, differing mainly in the number of TX antennas, the number of RX antennas and the respective placement of antennas. Such configurations result in a respective variety of spatial resolution parameter values, such as a vertical angular resolution value (φ) and a horizontal angular resolution value (θ). For example, as explained herein (e.g., in relation to FIGS. 2A, 2B, 2C and 2D), commercially available radar systems (e.g., MIMO radar systems) may include a TX antenna array and an RX antenna array that may correspond to, for example, rectangular, triangular and fractal virtual MIMO arrays. These virtual MIMO arrays correspond to respective angular resolution values (φ, θ) that are limited according to the number and placement of the RX and TX antennas.

### SUMMARY OF THE INVENTION

As explained herein, (e.g., in relation to FIGS. 2A, 2B, 2C and 2D), commercially available radar systems based on multiple antenna arrays, such as MIMO radar systems may correspond to an angular resolution that is limited by a product of the number of RX antennas and TX antennas along a predefined axis.

Furthermore, the design of currently available multiple antenna radar systems may be limited in a sense that it may not be easily scaled and/or manufactured to provide reproducible results between different instances of radar and/or elements (e.g., antennas, transmitters, receivers and the like) thereof.

Embodiments of the present invention may include an apparatus such as a radar apparatus, that may include an antenna array (e.g., a MIMO antenna array configuration) that may exceed the angular resolution performance of comparable commercially available apparatuses or systems (e.g., comparable MIMO radar systems) and may also be scalable and manufacturable to produce the required reproducible results. A commercially available apparatus or system (e.g., a MIMO radar system) may be referred to as ‘comparable’ in a sense that it may include a similar (e.g., the same) number of resources, or physical elements (e.g., transmitters, receivers, reception antennas, transmission antennas, etc.) and may require a substantially equal space (e.g., on a Printed Circuit Board (PCB) or other substrate) as an apparatus or system (e.g., a MIMO radar system) according to some embodiments of the present invention.

Embodiments of the present invention may include an apparatus, such as a radar, having multiple antennas. Embodiments of the apparatus may include: a first antenna array and a second antenna array. Each antenna array may include two or more antennas. Within each antenna array, the positions of each two adjacent antennas may be different in relation to both a first axis and a second axis, perpendicular to the first axis.

A pair of antennas may be referred to herein as being adjacent if for one of the antennas in the pair, no other antenna (e.g., in an antenna array) is closer to it than the other antenna in the pair.

According to some embodiments, the first antenna array and second antenna array may be linear in respect to the first axis. Additionally, the first antenna array and the second linear antenna array may be staggered along the second axis, so as to provide an angular resolution that may be superior to that of a second, comparable apparatus, where at least one of the first linear antenna array and second linear array are not staggered along the second axis. The second apparatus may be comparable to the apparatus of the present invention in a sense that it: (a) may have the same number of antennas in a first, linear antenna array, as that of the first antenna array of the apparatus of the present invention; (b) may have the same number of antennas in a second, linear antenna array, as that of the second antenna array of the apparatus of the present invention; (c) require a substantially equal space (e.g., on a PCB) as that required by the apparatus of the present invention.

According to some embodiments, the first antenna array may include N1 antennas that may be adapted to transmit RF energy, and the second antenna array may include N2 antennas that may be adapted to receive a reflection of the transmitted RF energy.

According to some embodiments, the N1 antennas of the first antenna array may be located along a first line parallel to the first axis, in a staggered array, and the N2 antennas of the second antenna array may be located along a second line parallel to the first axis in a staggered array.

According to some embodiments, the N1 antennas of the first antenna array may be aligned in parallel along the first axis and placed at intervals of a first predefined distance (D1) along the second axis, according to a first staggering order (SO1). Additionally, the N2 antennas of the second antenna array may be aligned in parallel along the first axis, and placed at intervals of the second distance (D2) along the second axis according to a second staggering order (SO2). It may be appreciated that in some embodiments D1 may be equal to D2. It may also be appreciated that in some embodiments SO1 may be equal to SO2.

According to some embodiments, D2 may be a product of D1 and SO1. Alternatively, D1 may be a product of D2 and SO2.

According to some embodiments, the N1 antennas of the first antenna array and the N2 antennas of the second antenna array may be adapted to create a virtual array, such as a MIMO virtual array. In some embodiments the virtual array may be shaped as a triangular lattice.

For example the N1 antennas of the first antenna array and the N2 antennas of the second antenna array may be adapted to create a virtual antenna array that may include: (a) a first number of virtual element positions along the first axis that may be at least equal to (N1 + N2 - 1); and (b) a second number of virtual element positions along the second axis, that may be at least equal to the product of SO1 and SO2.

According to some embodiments, the first antenna array may be physically divided along the first axis to at least one first subset and at least one second subset. For example, the at least one first subset and the at least one second subset may be located at a preconfigured distance along the first axis. In some embodiments, the distance between the at least one first subset and the at least one second subset may be set by (e.g., equal to) a width of the second antenna array.

Additionally, or alternatively, the second antenna array may be physically divided along the first axis to at least one first subset and at least one second subset. In this condition, the distance between the at least one first subset and the at least one second subset may be set by (e.g., equal to) a width of the first antenna array.

According to some embodiments, the N1 antennas of the first antenna array and the N2 antennas of the second antenna array may be embedded in a PCB. In some embodiments of the invention, the N1 antennas of the first antenna array may be embedded in a first PCB, and the N2 antennas of the second antenna array may be embedded in a second PCB.

Embodiments of the present invention may include a method of producing a virtual antenna array.

Embodiments of the method may include: (a) spatially locating a first set of two or more N1 transmission antennas along a first line, parallel to a first axis (e.g., an ‘X’ axis); and (b) spatially locating a second set of two or more N2 reception antennas along a second line, parallel to the first axis, so as to produce a virtual antenna array. The position of each pair of adjacent antennas (e.g., antenna A1 and A2) of the first set may be different in relation to both the first axis (e.g., the X axis) and a second axis (e.g., a Y axis), perpendicular to the first axis. Additionally, the positions of each pair of adjacent antennas (e.g., antenna B1 and B2) of the second set may be different in relation to both the first axis (e.g., the X axis) and a second axis (e.g., a Y axis). In other words, if position of adjacent antennas of the first antenna array is denoted by coordinates of perpendicular axes X and Y so: A1(X1, Y1), A2(X2, Y2), and position of adjacent antennas of the first antenna array is denoted by coordinates of perpendicular axes X and Y so: B1(X3, Y3) and B2(X4, Y4), then X1 is different from X2, Y1 is different from Y2, X3 is different from X4 and Y3 is different from Y4.

Embodiments may include locating the first set of antennas at a first staggered, linear array along the first axis, according to a first staggering order (SO1); and locating the second set of antennas at a second staggered, linear array along the second axis, according to a second staggering order (SO2), where SO1 and SO2 may be larger than 1.

According to some embodiments, the virtual antenna array may include: a first number of virtual element positions along the first axis that may be at least equal to a (N1 + N2 - 1); and a second number of virtual element positions along the second axis, that may be at least equal to the product of SO1 and SO2.

Embodiments of the invention may include an antenna array, that may include: a first staggered array of N1 antennas, embedded in a PCB and adapted to transmit an RF signal; and a second staggered array of N2 antennas, embedded in a PCB and adapted to receive a reflection of the RF signal. The N1 antennas of the first array may be aligned along a first axis and placed at intervals of a first predefined distance (D1) along a second axis, perpendicular to the first axis, and the N2 antennas of the second array may be aligned along a line parallel to the first axis, and placed at intervals of a second distance (D2) along the second axis.

According to some embodiments, the N1 antennas of the first array may be placed at intervals of distance D1 along the second axis according to a first staggering order (SO1), the N2 antennas of the second array may be placed at intervals of distance D2 along the second axis according to a second staggering order (SO2), and D2 may be a product of D1 and SO1.

According to some embodiments, the N1 antennas of the first array may be placed at intervals of distance D1 along the second axis according to a first staggering order (SO1), and the N2 antennas of the second array may be placed at intervals of distance D2 along the second axis according to a second staggering order (SO2), and D1 may be set as (e.g., be equal to) a product of D2 and SO2.

According to some embodiments, the first array of N1 antennas may be physically divided along the first axis to at least one first subset and at least one second subset, and a distance between the at least one first subset and the at least one second subset may be defined by a dimension of the second array of N2 antennas.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are schematic diagrams, depicting examples of multiple antenna arrays, that may be included in an apparatus or system according to some embodiments of the invention;

FIGS. 2A, 2B, 2C and 2D are schematic diagrams, depicting examples of antenna array configurations, as known in the art;

FIG. 3A is a schematic diagram, depicting an example of an antenna array (e.g., a MIMO antenna array configuration) that may be included in an apparatus or system (e.g., a MIMO antenna radar system) according to some embodiments of the invention;

FIG. 3B is a schematic diagram, depicting an example of an antenna array (e.g., a MIMO antenna array configuration) that may be included in an apparatus or system (e.g., a MIMO antenna radar system) according to some embodiments of the invention;

FIGS. 4A, 4B and 4C are schematic diagrams, depicting an additional example of an antenna array (e.g., a MIMO antenna array configuration) that may be included in an apparatus or system (e.g., a MIMO antenna radar system) according to some embodiments of the invention;

FIGS. 4D, 4E and 4F are schematic diagrams, depicting another example of an antenna array (e.g., a MIMO antenna array configuration);

FIG. 5 is a schematic diagram, depicting an additional example of an antenna array (e.g., MIMO antenna array configurations);

FIGS. 6 and 7 are schematic diagrams, depicting additional examples of antenna arrays (e.g., MIMO antenna array configurations) that may be included in an apparatus or system (e.g., a MIMO antenna radar system) according to some embodiments of the invention; and

FIG. 8 is a flow diagram, depicting a method of producing a virtual antenna array, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer’s registers and/or memories into other data similarly represented as physical quantities within the computer’s registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention may include an apparatus and/or system such as a radar apparatus, that may include an antenna array (e.g., a MIMO antenna array configuration) that may exceed an angular resolution performance of comparable, currently available apparatuses or systems (e.g., comparable MIMO radar systems) and may also be scalable and manufacturable to produce the required reproducible results.

In another aspect of the invention, embodiments may include an antenna array that may exceed an angular resolution performance of comparable, currently available antenna arrays.

In yet another aspect of the invention, embodiments may include a method of producing a virtual antenna array that may exceed an angular resolution performance of comparable, currently available virtual antenna arrays.

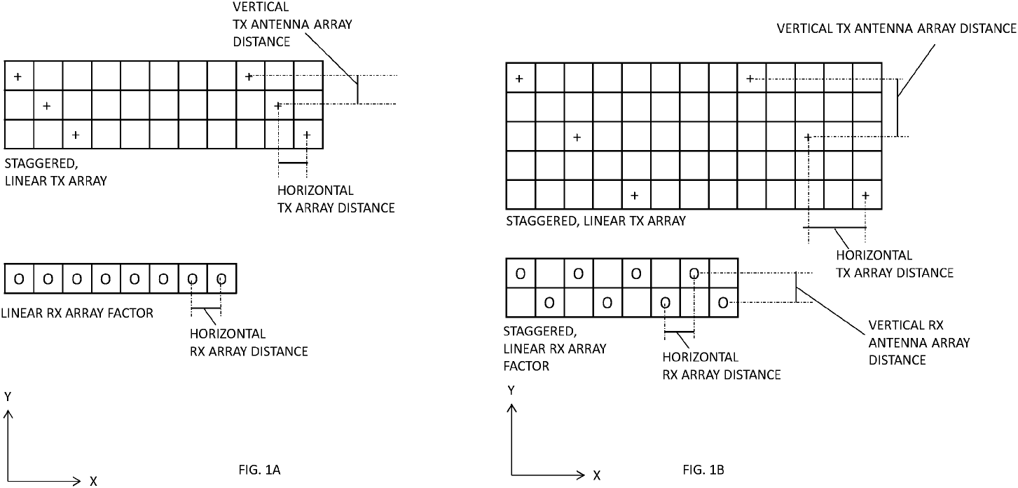

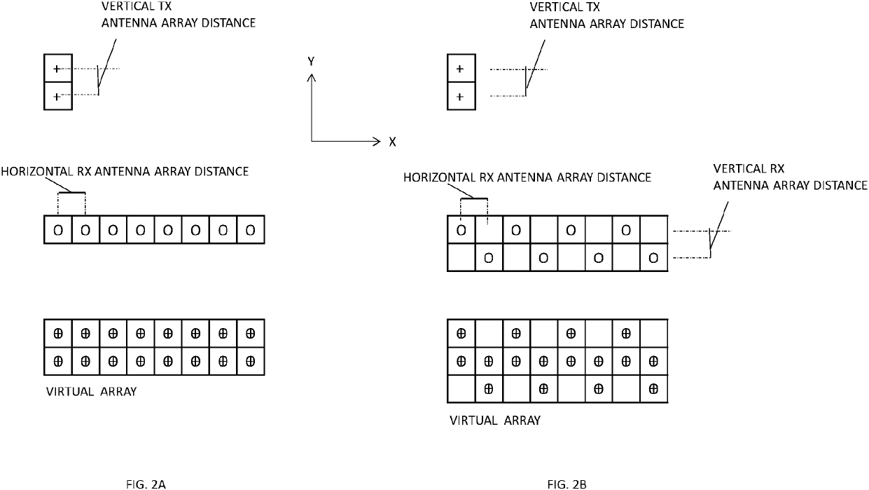

Reference is now made to FIGS. 1A and 1B are schematic diagrams, depicting examples of multiple antenna arrays, that may be included in an apparatus or system according to some embodiments of the invention. As shown in the examples of FIG. 1A and FIG. 1B, the apparatuses may include a first antenna array that may be used for transmitting an RF signal (e.g., a TX array) and a second antenna array that may be used for receiving an RF signal (e.g., an RX array). A representation of a location of the TX antennas in the TX array is schematically marked herein by the ‘+’ symbol, and a representation of a location of the RX antennas in the RX array is schematically marked herein by the ‘○’ symbol. It may be appreciated that the term ‘location’ may relate to any consistent characteristic of a physical location of the antennas in the antenna arrays. For example, a location may refer to a specific edge (e.g., a ‘top’ edge, a ‘bottom’ edge, etc.) of each respective antenna in an antenna array. In another example, location may refer to a center (e.g., a geometrical center) of each respective antenna in an antenna array.

As shown in FIG. 1A and FIG. 1B, the RX antenna arrays and the TX antenna arrays of the respective figures may be characterized by predefined distances among or between their respective antenna components. For example: (a) the minimal distance between antennas of a TX array, along the X axis are marked as “Horizontal TX array distance”; (b) the minimal distance between antennas of a TX array, along the Y axis are marked as “Vertical TX array distance”; (c) the minimal distance between antennas of a RX array, along the X axis are marked as “Horizontal RX array distance”; and (d) the minimal distance between antennas of a RX array, along the Y axis are marked as “Vertical RX array distance”.

As shown in FIG. 1A and FIG. 1B, the TX antenna array may be referred to as linear, in a sense that antennas of the TX antenna array (‘+’) may be generally aligned along a line or axis (e.g., the X axis). Similarly, the RX antenna array may also be referred to as linear, in a sense that antennas of the RX antenna array (‘O’) may be generally aligned along a line or axis (e.g., also the X axis).

The antenna array of the example of FIG. 1A may be implemented in currently available systems and/or apparatuses, such as currently available MIMO-based radar systems.

As shown in FIG. 1A, the TX antenna array may be referred to as ‘staggered’ in a sense that the positions of antennas of the antenna array may be staggered along a second axis (e.g., along the Y axis); e.g. the antennas are not arranged in a regular manner on one axis, but the placement moves along a second axis as the placement moves along a first axis. The staggered antenna array (in this example, the TX array) may be referred to as having a staggering order (SO), representing the number of antenna positions along the staggering axis. In this example, the SO of the TX antenna array is 3, as there are 3 possible locations or positions of TX antennas along the Y axis. In a complementary manner, the RX antenna array of the example of FIG. 1A is not staggered, as there is only one possible position for antennas along the Y axis.

The antenna array of the example of FIG. 1B may be implemented by embodiments of the present invention. It may observed by comparison with FIG. 1A, that: (a) the RX antenna array of the example of FIG. 1B is staggered, with a staggering order of 2, whereas the RX antenna array of the example of FIG. 1A is not staggered; and (b) some distances (e.g., the vertical TX antenna array distance, the horizontal TX antenna array distance and the vertical RX antenna array distance) are different between FIG. 1B (depicting an embodiment of the present invention) and FIG. 1A (depicting an example that may be included in currently available systems).

It may be apparent from the example depicted in FIG. 1B, that embodiments of the invention may include an apparatus that: (a) includes a first antenna array (e.g., a TX array) and a second antenna array (e.g., RX array), where each antenna array includes a set of (e.g., two or more) antennas; and (b) for both, or within each of the, antenna arrays, the positions of each two adjacent antennas (where two antennas may be adjacent for one of the antennas in the pair, no other antenna is closer to it than the other antenna in the pair) are different in relation to a first axis (e.g., the X axis) and in relation to a second axis (e.g., the Y axis), perpendicular to the first axis.

It may be appreciated by a person skilled in the art that currently available antenna arrays (e.g., as depicted in the example of FIG. 1A) and antenna arrays of embodiments of the present invention (e.g., as depicted in the example of FIG. 1B) may be comparable, as explained above. In other words, a specific array in the prior art may be comparable to a specific array of the present invention in a sense that they may (a) include the same number of resources, or physical elements (e.g., transmitters, receivers, reception antennas, transmission antennas, etc.); and (b) require a substantially equal space on a PCB; while the two comparable antenna array may differ as explained elsewhere herein. For example, a difference (e.g., an addition) in consumed space on a PCB between the antennas of FIG. 1A and the antennas of FIG. 1B (e.g., due to the staggering of antenna arrays of FIG. 1B) may be negligible (e.g., normally measured in millimeters), in relation to an overall form factor of the antenna arrays as a whole (e.g., normally measured in centimeters).

Nevertheless, it may also be appreciated by a person skilled in the art, that the antenna arrays of embodiments of the present invention (e.g., as depicted in the example of FIG. 1B) may provide a superior angular resolution performance in relation to currently available, comparable (comparable in size, layout, space on a PCB, etc.) antenna array of the prior art (e.g., as depicted in the example of FIG. 1A). For example, and as depicted in FIG. 1B, each antenna element ‘+’ of the TX antenna array may collaborate with each antenna element ‘○’ of the RX antenna array, to produce information pertaining to the Y axis. Since the SO of the TX array of FIG. 1B is 3 and the SO of the TX array of FIG. 1B is 2, an apparatus using the antenna arrays of FIG. 1B may produce information pertaining to 6 different locations along the Y axis. In comparison, the currently available, comparable antenna array depicted in the example of FIG. 1A, in which SO of the RX array is 1, may produce information pertaining to only 3 different locations along the Y axis.

In other words, embodiments of the apparatus of the present invention may include a first linear antenna array (e.g., a TX array) and a second linear antenna array (e.g., RX array). The first linear antenna array and the second linear antenna array may both be staggered along a line or axis (e.g., along the Y axis), so as to provide an angular resolution that may be superior to a comparable apparatus of which at least one of the first linear antenna array and second linear array is not staggered along the axis.

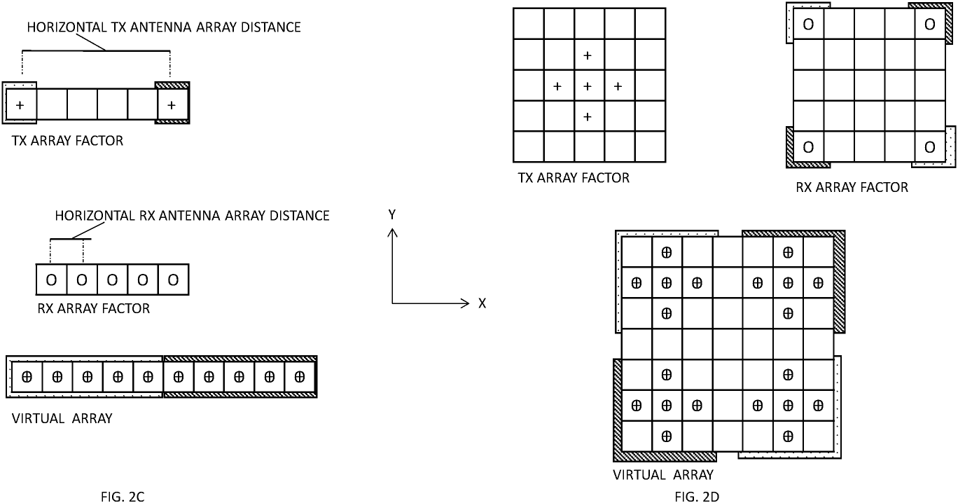

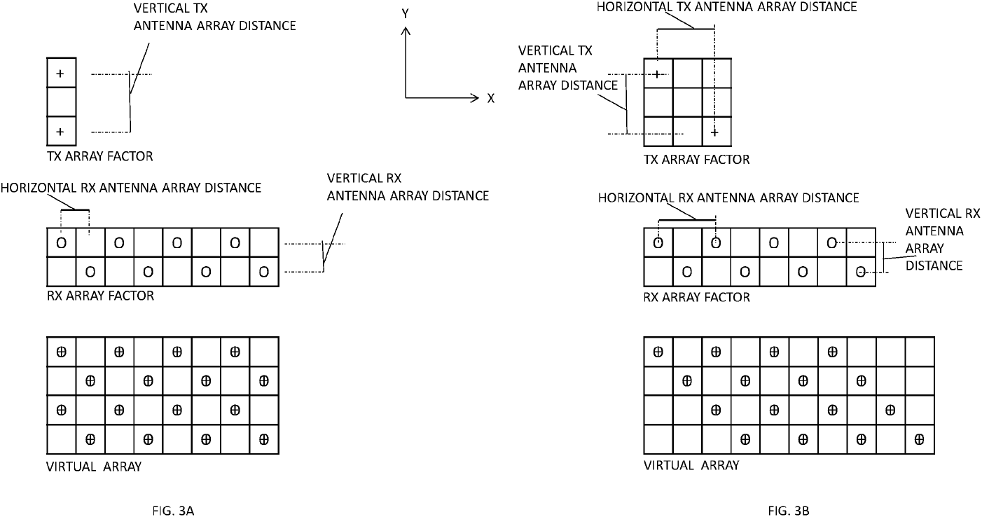

Reference is now made to FIG. 2A which is a schematic diagram, depicting an example of an antenna array, such as a MIMO antenna array configuration, as known in the art.

The positions of TX antennas are schematically marked by a ‘+’ symbol, and the positions of TX antennas are schematically marked by the ‘○’ symbol. It may be appreciated that this notation (e.g., of ‘+’ and ‘○’ to respectively represent TX antenna positions and RX antenna positions) is used herein throughout this document. The term ‘position’ in this context may refer herein to a physical point in space, representing a location of the respective antenna. For example, a position of an antenna may refer herein to a physical location of an RF radiation element (e.g., a center-phase radiation element), a geometric center of the antenna, a geometric edge point of the antenna, and the like. It may be appreciated that the schematic position (e.g., ‘+’ and ‘○’) as representing an antenna’s physical location may change according to specific implementations (e.g., according to geometries of the implemented antennas), but may nevertheless serve to indicate a configuration or relation between antennas (e.g., in an antenna array or set).

As shown in the example of FIG. 2A, a first array of antennas may be a linear array (e.g., located along a first axis, such as the Y axis) of TX antennas and a second array of antennas may be a linear array (e.g., along a second axis, such as the X axis) of RX antennas.

As known in the art, a subsequent virtual array may be formed as a convolution of the RX array and TX array. Elements of the virtual array are schematically marked by the ‘⊕’ symbol. It may be appreciated that this notation (i.e., ‘⊕’ symbols to represent virtual array elements) is used herein throughout this document.

As shown in the example of FIG. 2A, the virtual array of this example is a rectangular array, as commonly referred to in the art. The positions of the virtual array elements (‘⊕’) are dictated by a convolution of the RX array and TX array. In this example it may be noted that the overall number of array elements (in this example: 16) is equal to the product of the number (e.g., N1) of TX antennas (in this example, N1=2) and the number (e.g., N2) of RX antennas (in this example, N2=8).

It may be appreciated that N1 and N2 may have integer values that may be different from the numbers in the examples depicted herein. For example, in some embodiments N1 and N2 may be equal integer numbers. Alternatively, or N1 and N2 may be non-equal integer numbers. According to some embodiments, at least one of N1 and N2 may be equal to, or larger than 2.

The total number of positions of the virtual array elements (‘⊕’) along any one of the axes (e.g., the Y axis and X axis) is limited by a convolution of the number of RX and TX antennas along the respective axes. Hence, also the angular resolution along these axes (e.g., φ, θ, respectively) is limited by a convolution of the number of RX and TX antennas along the respective axes. In this example, the number of TX antennas (‘+’) along the Y axis is 2, and the number of RX antennas (‘○’) along the Y axis is 1, hence the number of virtual array elements (‘⊕’) along the Y axis is: conv(2, 1) = 2+1-1 = 2. In a complementary manner, the number of TX antennas (‘+’) along the X axis is 1, and the number of RX antennas (‘○ ’) along the X axis is 8, hence the number of virtual array elements (‘⊕’) along the X axis is: conv(1,8) = 1+8-1 = 8.

Reference is now made to FIG. 2B which is schematic diagram, depicting another example of an antenna array configuration, as known in the art. As shown in the example of FIG. 2B, one of the array of antennas (in this example, the RX array) may be a linear, staggered antenna array. The array may be referred to as linear, as it is generally aligned along a line or axis (e.g., the X axis). The array may be referred to as staggered in a sense that the positions of antennas of the antenna array may be staggered along a second axis (e.g., along the Y axis). The staggered antenna array (in this example, the RX array) may be referred to as having a staggering order (SO), representing the number of antenna positions along the staggering axis. In this example, the SO of the RX antenna array is 2, as there are 2 possible locations or positions of RX antennas along the Y axis.

As shown in FIG. 2B, the number of positions of the virtual array elements (‘⊕’) are dictated by a convolution of the positions of the RX antennae (‘○’) of the RX antenna array and the positions of the TX antennae (‘+’) of the TX antenna array.

In this example, the number of positions of the array elements (‘⊕’) along the Y axis (i.e., 3) is the product of a convolution of the number of TX antennae (‘+’) along the Y axis (i.e., 2) and the number of RX antennae (‘○’) along the Y axis (i.e., 2), because conv (2,2) = 2+2-1 = 3. Therefore, a vertical (e.g., along the Y axis) angular resolution value (φ) corresponds to 3 positions of array elements (‘⊕’) along the Y axis, and is improved in relation to the angular resolution value (φ) of the antenna array of FIG. 2A (corresponding to 2 positions along the Y axis).

Reference is now made to FIG. 2C which is a schematic diagram, depicting another example of an antenna array configuration, as known in the art. As shown in FIG. 2C, both the RX antenna array and the TX antenna array are linear, and are aligned along the same axis (e.g., the X axis).

In this condition, to avoid overlap of virtual elements, a first distance (e.g., a horizontal distance) between antenna positions of a first antenna array (in this example the TX array) is set according to a second distance (e.g., a horizontal distance) between antenna positions of the second antenna array (in this example the RX array) and according to the number of antennas of the second array (in this example the N2 = 5 RX antennas). Typically the first distance is different from the second distance. In other words, in this example, the horizontal TX array gap or distance (e.g., 5 distance units) is set to be a product of the horizontal RX array distance (e.g., 1 distance unit) and the number of RX antennae (N2 = 5).

As shown in FIG. 2C, the number of positions of the array elements (‘⊕’) along the Y axis is 1 and number of positions of the array elements (‘⊕’) along the X axis (e.g., 10) corresponds to a product of the number of RX and TX antennae along the X axis (e.g., 2*5=10). Therefore, a horizontal (e.g., along the X axis) angular resolution value (θ) also corresponds to the product of the number of RX and TX antennae along the X axis.

Reference is now made to FIG. 2D which is another schematic diagram, depicting an example of an antenna array configuration, as known in the art. As shown in the example of FIG. 2D, the convolution of the positions of RX antennas and TX antennas may form a virtual array that is commonly referred to in the art as a ‘fractal’ array, that may include a multiplication or a plurality of ‘seed’ or ‘kernel’ forms, such as the cross-shape formed by TX antennas (‘+’) of the TX antenna array in this example.

It may be appreciated by a person skilled in the art that fractal array configurations may theoretically be scaled to include any order of duplication of the kernel of a first array (e.g., in this example the cross-shape formed by TX antennas (‘+’) of the TX antenna array) with the RX antennae (‘○’). However, practical implementation of such an array may be limited by various aspects of design and/or manufacture.

For example, an implementation of an RF antenna array on a PCB may be limited by constraints that may be imposed by: the PCB size, dimensions of each antenna element, placement of other modules on the PCB, the wiring required for transferring RF signals to and from the antennas, etc. Alternatively, neglecting to adhere to these limitations may lead to RF signals that may be of poor quality (e.g., noisy), and to RF systems that may present poor quality, and/or non-reproducible performance.

Embodiments of the invention may include RF antenna arrays and/or methods of placing RF antennas in an antenna array. The resulting RF antenna array may be easy to scale, may provide reproducible performance and may provide angular resolution that may be superior to currently available equivalent or comparable antenna arrays (e.g., antenna arrays having a similar number of physical antennas and consuming a similar amount of space or area).

Reference is now made to FIG. 3A, which is a depicting an example of an antenna array (e.g., a MIMO antenna array configuration) that may be included in an apparatus or system (e.g., a MIMO antenna radar system) according to some embodiments of the invention. As shown in FIG. 3A, the RX antenna array is linear in a sense that the RX antennas are located along a first (e.g., X) axis, and staggered (e.g., placed intermittently) along a second (e.g., Y) axis. The RX antennae of the RX antenna array are staggered according to a staggering order of 2 (e.g., showing two positions along the Y axis), and located at a first distance (marked “vertical RX antenna array distance”) between each antenna element.

By comparing the RX (‘○’) array, TX (‘+’) array and virtual array (‘⊕’) of FIG. 3A with those of FIG. 2A, it may be understood that the virtual array of FIG. 3A includes the same number of elements (‘⊕’) as that of FIG. 2A (e.g., 16 elements, corresponding to the product of 2 TX antennas and 8 RX antennas). However, the number of positions of virtual array elements (‘⊕’) along the Y axis in FIG. 3A is 4, whereas the number of positions of virtual array elements (‘⊕’) along the Y axis in FIG. 2A is only 2. This increase in virtual array element positions between FIG. 2A and FIG. 3A corresponds to an increase of the vertical angular resolution value (φ). The horizontal angular resolution value (θ) remains the same between the arrays depicted in FIG. 2A and FIG. 3A. In other words, the placement of the RX and TX antennae of FIG. 3A produces a virtual array that may be equivalent, in terms of vertical and horizontal angular resolution values to a rectangular virtual array having 4×8=32 elements (‘⊕’). This configuration produces an RF antenna array that is characterized by performance (in terms of vertical and horizontal angular resolution values) that exceeds the performance of comparable arrays (e.g., the arrays depicted in FIG. 2A, having the same number of antenna elements) without any addition of RF antenna elements. Furthermore, as explained herein, the marked positions of RX (‘○’) and TX (‘+’) antennas in FIG. 3A is schematic (e.g., representing a location on each antenna, such as its middle point). Hence, it may be appreciated that any additional space or area (e.g., on a printed circuit board) that may be required by the staggering of the RX (‘○’) and/or TX (‘+’) antenna arrays may be negligible in relation to the space already consumed by the RX (‘○’) and/or TX (‘+’) antenna arrays.

As shown in FIG. 3A, an improvement in the vertical angular resolution value (φ) may be due to placement of the TX antennae along a specific axis (e.g., the Y axis) at a distance (e.g., marked “vertical TX antenna array distance”) that may accommodate the dimension of the RX array in the respective axis. For example, the TX antennae may be positioned along the Y axis, spaced at a vertical TX antenna array distance (e.g., 2 space units) that is equal to the product of the vertical RX antenna array distance (in this example 1 space unit) and the RX antenna array staggering order (in this example, 2), (2×1=2).

Reference is now made to FIG. 3B, which is a schematic diagram, depicting an example of an antenna array (e.g., a MIMO antenna array configuration) that may be included in an apparatus or system (e.g., a MIMO antenna radar system) according to some embodiments of the invention.

As shown in FIG. 3B, an apparatus (e.g., a MIMO radar apparatus) may include a first antenna array and a second antenna array, each antenna array including a set of antennas. For example, the first antenna array may be a TX antenna array including a plurality or set of N1 TX antennas (‘+’), adapted to transmit RF energy and the second antenna array may be an RX antenna array, including a plurality or set of N2 RX antennas (‘○’), adapted to receive a reflection of the transmitted RF energy. As shown in FIG. 3B, for both, or within each of the, antenna arrays (e.g., the TX antenna array and the RX antenna array), the positions of each two adjacent antennas (e.g. each pair of antennas such that for at least one in the pair no other antenna is closer than the other in the pair) are different in relation to a first axis (e.g., the X axis) and in relation to a second axis (e.g., the Y axis), perpendicular to the first axis.

By comparing FIG. 3B with FIG. 3A, it may be understood that the virtual array of FIG. 3B includes the same number of elements (‘⊕’) as that of FIG. 3A (16 elements, corresponding to the product of 2 TX antennas and 8 RX antennas). However, number of positions of virtual array elements (‘⊕’) along the X axis in FIG. 3B is 10, whereas the number of positions of virtual array elements (‘⊕’) along the X axis in FIG. 3A is only 8.

The increase in the number of virtual array element positions between FIGS. 3A and 2B may be due to placement of the TX antennae at a relational distance along the X axis (marked horizontal TX antenna array distance, e.g., 2 distance units) that corresponds to a distance between RX antennae along the same X axis (marked horizontal RX antenna array distance, e.g., 2 distance units). The increase in the number of virtual array element positions may correspond to an increase of the horizontal angular resolution value (θ, along the X axis), and to a decrease in the vertical angular resolution value (φ, along the Y axis) in the rightmost and leftmost parts of the scanned field of view. Such a configuration may accommodate specific applicative needs, that may trade-off performance (e.g., angular resolution along a first axis) at one or more first regions of the field of view, for performance (e.g., angular resolution along a second axis) at one or more second regions of the field of view.

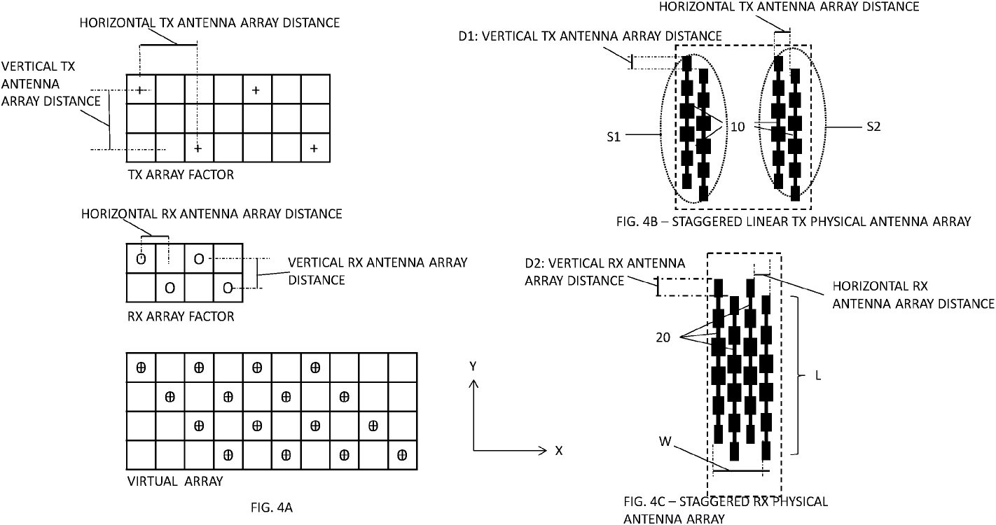

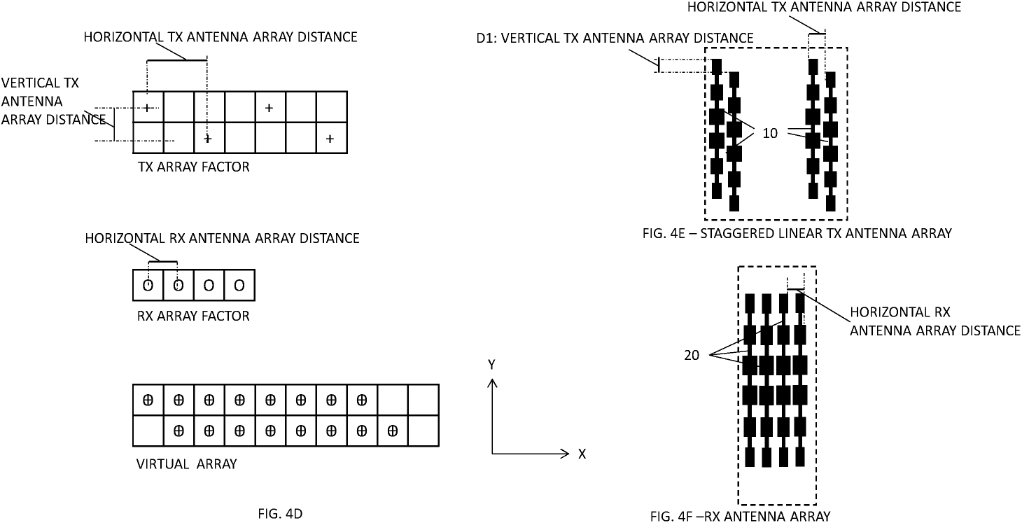

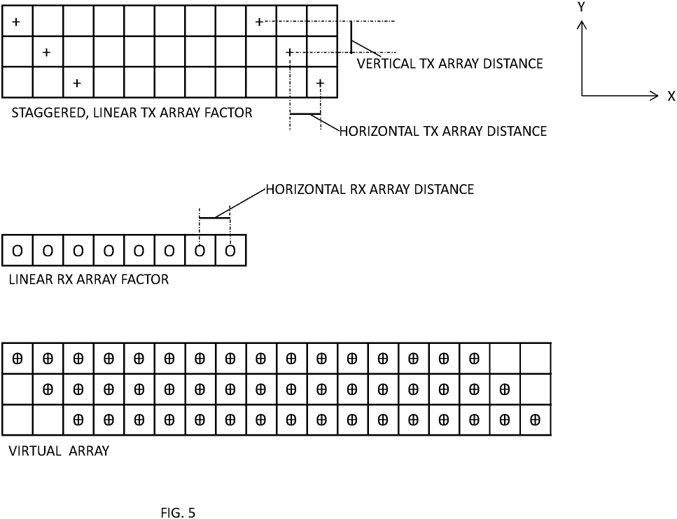

Reference is now made to FIGS. 4A, 4B and 4C, which are schematic diagrams, depicting an additional example of an antenna arrays (e.g., a MIMO antenna array configuration) that may be included in an apparatus or system (e.g., a MIMO antenna radar system) according to some embodiments of the invention.

According to some embodiments, the antenna array may include a first periodically staggered array of N1 antennas 10 (as schematically depicted in FIG. 4B) adapted to transmit an RF signal and a second periodically staggered array of N2 antennas 20 (as schematically depicted in FIG. 4C) adapted to receive reflection of the RF signal. The term periodically may refer in this context to a space-wise repetition of a pattern of staggering, as depicted in the examples included herein.

FIG. 3A includes a schematic TX antenna array diagram (e.g., ‘+’ elements), a schematic RX antenna array diagram (e.g., ‘○’ elements), and a subsequent virtual array diagram (‘⊕’ elements).

FIGS. 4B and 4C are schematic diagrams, depicting a physical array of TX antennas 10 and RX antennas 20, respectively. In the example of FIG. 4B and FIG. 4C, the antennas (e.g., 10, 20) may have a dimension that corresponds to an RF working frequency, as known in the art. For example, as depicted in FIGS. 4B and 4C, the TX antennas 10 and RX antennas 20 may be elongated (e.g., along the Y axis), and may have a length that may correspond, for example, to a half - wavelength of the working frequency. According to some embodiments, one or more antennas (e.g., 10, 20) may include antenna patches, as known in the art. These patches are schematically marked as rectangular patches along the antennas of FIGS. 4B and 4C.

According to some embodiments of the invention, the first array or set of physical antennas (e.g., TX antennas 10, adapted to transmit an RF signal) and the second array or set of physical antennas (e.g., RX antennas 10, adapted to receive reflection of the RF signal) may be embedded or printed on a printed circuit board.

As shown in the physical TX antenna 10 array diagram of FIG. 4B and the corresponding schematic representation of the TX antennas (‘+’) in FIG. 4A, embodiments of the invention may include spatially locating a first set of N1 (N1>1, e.g., 4) physical antennas (e.g., TX antennas) at a first periodically staggered, linear antenna array (e.g., the TX antenna array) along a first axis (e.g., the X axis). The antennas (e.g., TX antennas 10) may be staggered according to a first staggering order (SO1>1, e.g., 2).

In other words, the N1 antennas of the TX antenna array may be aligned in parallel along a first axis (e.g., the X axis) and intermittently placed or staggered at a first predefined distance (e.g., D1, marked as the “vertical TX antenna array distance” in FIG. 4B) along a second axis (e.g., the Y axis), perpendicular to the first axis (e.g., the X axis), according to a first staggering order (e.g., SO1>1, in this example: 2).

As shown in the physical RX antenna 20 array diagram of FIG. 4C and the corresponding schematic representation of the RX antennas 20 (‘○’) in FIG. 4A, embodiments of the invention may include spatially locating a second set of N2 (N2>1, e.g., 4) physical antennas (e.g., RX antennas 20) at a second periodically staggered, linear antenna array along the first axis (e.g., also along the X axis). The antennas (e.g., RX antennas 10) may be staggered according to a second staggering order (SO2>1, e.g., 2).

In other words, the N2 antennas of the second array may be aligned in parallel along the first axis (e.g., the X axis) and may be intermittently placed or staggered at a second distance (e.g., D2, marked as the “vertical RX antenna array distance” in FIG. 4C) along the second axis (e.g., the Y axis) according to a second staggering order (SO2>1, in this example: 2).

According to some embodiments, the first array of N1 antennas (e.g., TX antennas) may be physically divided along the first axis (e.g., the X axis) to at least one first subset (e.g., S1 of FIG. 4B) and at least one second subset (e.g., S1 of FIG. 4B). In other words, the at least one first subset (e.g., S1 of FIG. 4B) and the at least one second subset (e.g., S1 of FIG. 4B) may be located at a preconfigured distance along the first axis (e.g., the X axis). The distance between the at least one first subset (e.g., S1) and the at least one second subset (e.g., S1) may be defined by a width (W) of the second array of N2 antennas (e.g., the RX antenna array). Alternatively, or additionally, the second array of N2 antennas (e.g., RX antennas) may be physically divided along the first axis (e.g., the X axis) to at least one first subset and at least one second subset, and the distance between the at least one first subset and the at least one second subset may be defined by a width of the first array of N1 antennas (e.g., the TX antenna array).

A virtual antenna array that corresponds to the RX antenna array and the TX antenna array may thus be formed.

The virtual antenna array may include a number of virtual element (‘⊕’) that may be a product of N1 and N2 (e.g., 16=N1*N2).

However, as explained herein (e.g., in relation to FIG. 3A and FIG. 3B), the staggering of both the linear RX antenna array and the linear TX antenna array may arrange the virtual elements (‘⊕’) in the virtual array such as to correspond to an improved vertical angular resolution value (φ) and/or horizontal angular resolution value (θ). The term ‘improved’ referring to a higher or better angular resolution in relation to a comparable (e.g., having the same number of TX and RX antenna elements) configuration where at least one of the RX linear antenna array and TX linear antenna array has not been staggered, as explained in relation to the example of FIGS. 3D, 3E and 3F.

Reference is now made to FIGS. 4D, 4E and 4F, which are schematic diagrams, depicting an example of an antenna array (e.g., a MIMO antenna array configuration) that may be included in currently available antenna apparatuses.

By comparing FIGS. 4A, 4B and 4C with respective FIGS. 4D, 4E and 4F, it may be observed that in the example of FIGS. 4D, 4E and 4F, at least one linear (e.g., along a first axis such as the X axis) antenna array (e.g., the RX antenna linear array) has not been staggered. Consequently, the resulting virtual array includes less positions of virtual array elements (‘⊕’) along the second axis (e.g., the Y axis). In this example, the virtual array of FIG. 4A includes 4 positions along the Y axis, whereas the virtual array of FIG. 4D includes only 2 positions along the Y axis. Subsequently, the virtual array of FIG. 4A may correspond to a superior vertical angular resolution value (φ) in relation to the virtual array of FIG. 4D.

As elaborate herein, embodiments of the present invention may include an antenna apparatus (e.g., as depicted herein in FIGS. 4A, 4B and 4C), that may include a first array (e.g., a TX array) of N1 antennas and a second array (e.g., a TX array) of N2 antennas. According to some embodiments, the N1 antennas may be embedded or printed in a first printed circuit board (PCB) or other substrate or support. According to some embodiments, the N2 antennas may be embedded or printed in a second PCB or other substrate or support. Alternatively, the N1 antennas of the first antenna array and the N2 antennas of the second antenna array may all be printed or embedded in the same PCB.

It may be appreciated by persons skilled in the art, by comparing FIGS. 4A-4C with corresponding FIGS. 4D-4F, that the improved angular resolution of the configuration depicted in FIGS. 4A-4C of the present invention (e.g., in relation to a comparable, currently available configuration such as that of FIGS. 4D-4F) may not require addition of elements (e.g., electronic elements such as receivers, transmitters, antennas etc.).

Furthermore, it may be appreciated, by comparing FIGS. 4C and 4F, that the improved angular resolution of embodiments of the present invention (e.g., as depicted in FIGS. 4A-4C) in relation to currently available antenna apparatuses (e.g., as depicted in FIGS. 4D-4F) may be obtained by minute or subtle adaptation of the linear antenna arrays. For example, such changes may include minor adaptations of wiring and/or location of RF antennas on a PCB board. As depicted in FIG. 4C, such minute adaptations may include location of physical antennas in a staggered array, defined by a distance (e.g. D2, vertical RX antenna array distance) that may typically be much smaller than a dimension (e.g., length) of an entire RF antenna element (e.g., L). Subsequently, it may also be appreciated that any additional space (e.g., on a PCB board) that may be required to obtain the improved angular resolution may be negligible, in relation to the overall space that may be required by the first (e.g., TX) antenna array and/or the second (e.g., RX) antenna array.

It may also be appreciated by persons skilled in the art that such adaptations may not be applicable for other types of antenna arrays (such as fractal antenna array, as discussed in relation to the example of FIG. 2D), due to the inherent complexity of location, orientation and wiring of such configurations.

In other words, it may be appreciated by persons skilled in the art that implementation of an antenna apparatus that may include an RX antenna array and a TX antenna array (such as fractal arrays, as elaborated herein) may not be scalable (e.g., enable addition of antenna elements), compact (e.g., space-wise) and/or provide reproducible results (e.g., due to extensive wiring), as elaborated in relation to embodiments of the invention (e.g., in relation to FIGS. 3A-3C, 5 and 6).

Reference is now made to FIG. 5 which is a schematic diagram, depicting an example of an antenna array (e.g., a MIMO antenna array configuration). The antenna array of the example of FIG. 5 may be implemented in currently available systems and/or apparatuses.

As shown in the example of FIG. 5, the linear TX antenna array (‘+’) may be staggered according to a first staggering order (SO1>1, e.g., 3), and the linear RX antenna array (‘○’) may not be staggered.

It may be noted that (a) the resulting virtual array includes 3 rows, or 3 positions of virtual array elements (‘⊕’) along the Y axis; and (b) the resulting virtual array includes 18 positions of virtual array elements (‘⊕’) along the X axis.

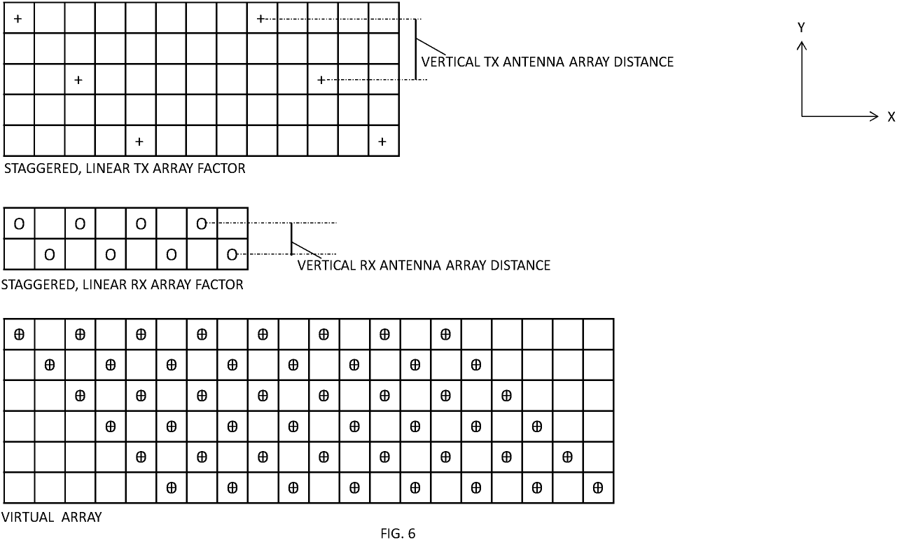

Reference is now made to FIG. 6 which is a schematic diagram, depicting an additional example of an antenna array (e.g., a MIMO antenna array configuration) that may be included in an apparatus or system (e.g., a MIMO antenna radar system), according to some embodiments of the invention. The antenna array in the example of FIG. 6 may be referred to as comparable (e.g., having the same number of elements such as receivers, transmitters, TX antennas and RX antennas) to the configuration depicted in FIG. 5.

According to some embodiments, and as shown in FIG. 6, the N1 (in this example, 6) antennas (‘+’) of a first antenna array (e.g., the TX antenna array) may be located in a periodic, or spatially repetitive staggered array, along a first line parallel to a first axis (e.g., the X axis), and N2 (in this example, 8) antennas (‘○’) of the second antenna array (e.g., the RX antenna array) may be located along a second line, parallel to the first axis (e.g., the X axis) in a periodically staggered array.

In other words, as shown in FIG. 6, the N1 antennas (‘+’) of the TX antenna array may be aligned in parallel along, or in the direction of the first axis (e.g., the X axis), and may be intermittently or periodically (e.g., repetitively along the X axis) placed at intervals of a first distance D1 (marked as “vertical TX antenna array distance”) along the second axis (e.g., the Y axis), according to a first staggering order SO1 (in this example, SO1=3). Additionally, or alternatively, the N2 antennas (‘○’) of the RX antenna array may be aligned in parallel along, or in the direction of the first axis (e.g., the X axis), and may be intermittently or periodically (e.g., repetitively along the X axis) placed at intervals of a second distance D2 (marked as “vertical RX antenna array distance”) along the second axis (e.g., the Y axis), according to a second staggering order SO2 (in this example, SO2=2).

By comparing FIG. 5 with FIG. 6, it may be observed that the RX array of FIG. 6 has been staggered along the Y axis, in relation to the RX array of FIG. 4. Consequently, the virtual array of the example depicted in FIG. 6 has 6 rows or positions of virtual array elements (‘⊕’) along the Y axis, whereas the virtual array of the example depicted in FIG. 5 has 3 rows or positions of virtual array elements (‘⊕’) along the Y axis.

Therefore, embodiments of the present invention that may include an apparatus including an RX antenna array and a TX antenna array as depicted in the example of FIG. 6, may correspond to a superior vertical angular resolution value (φ) in relation to that of a comparable apparatus as known in the art (e.g., having the same number of antennas and consuming a similar amount of physical space), as depicted in the example of FIG. 5.

As shown in FIG. 6, the virtual antenna array may include a number of virtual element (‘⊕’) positions along the first axis (e.g., the X axis, along which the TX antenna array and the RX antenna array are aligned) that is at least equal to a convolution vector length of N1 (e.g., the number of TX antennas) and N2 (e.g., the number of RX antennas), e.g., at least equal to (N1 + N2 - 1). In this example, the number of virtual element (‘⊕’) positions along the X axis is 20; N1 = 6; N2 = 8; Conv(6,8) = 6+8-1=13; and 20>13.

As shown in FIG. 6, the virtual antenna array may include a number of virtual element (‘⊕’) positions along a second axis (e.g., the Y axis, along which the linear arrays are staggered), perpendicular to the first axis, that is at least equal to the product of SO1 (e.g., the staggering order of the TX linear antenna array) and SO2 (e.g., the staggering order of the RX linear antenna array). In this example: the number of virtual element (‘⊕’) positions along the Y axis is 6; SO1= 3; SO2 = 2; and 2*3=6.

It may be appreciated that the staggering of both linear antenna arrays (e.g., the TX antenna array and RX antenna array) is calculated or matched so as to ensure correct location (e.g., avoid overlap) of the virtual array elements (‘⊕’) in the virtual array. In this example, the vertical TX array factor distance (e.g., two distance units) is calculated according to the product of the vertical RX array factor distance (e.g., one distance unit) and the RX antenna array staggering order (e.g., 2). In other words, D1 of FIG. 4B may be set as a product of D2 of FIG. 4C and SO2.

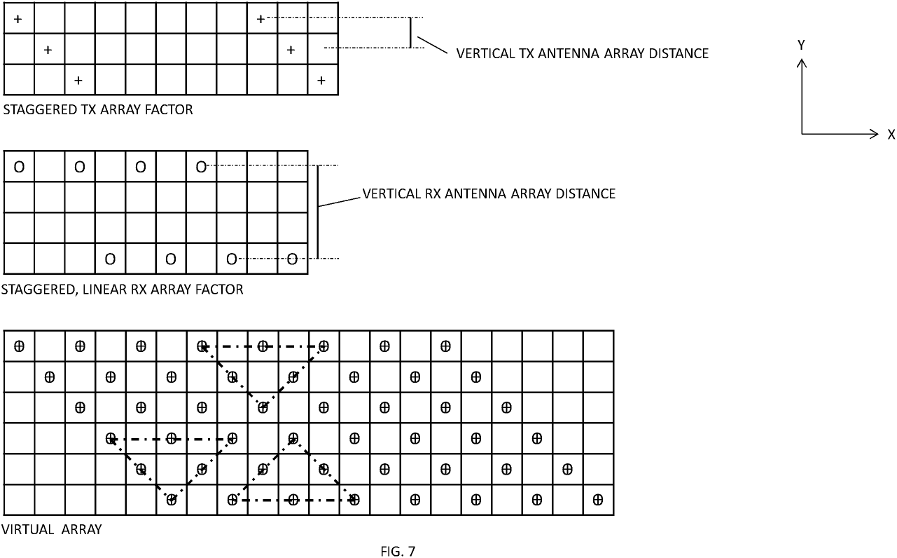

Reference is now made to FIG. 7 which is a schematic diagram, depicting an additional example of an antenna array (e.g., a MIMO antenna array configuration) that may be included in an apparatus or system (e.g., a MIMO antenna radar system), according to some embodiments of the invention. The antenna array in the example of FIG. 7 may be comparable (e.g., having the same number of elements such as receivers, transmitters, TX antennas and RX antennas) as the configuration depicted in FIG. 5 and FIG. 6.

By comparing FIG. 7 with FIG. 6, it may be observed that the same virtual array has been obtained, using the same staggering order (e.g., SO1=3, SO2=2), but a different calculation or matching of distances:

In the example of FIG. 6, the vertical TX antenna array distance (e.g., two distance units) is calculated according to the product of the vertical RX antenna array distance (e.g., one distance unit) and the RX antenna array staggering order (e.g., 2). In other words, distance element D2 of FIG. 4C may be calculated or set as a product of D1 of FIG. 4B and SO1.

In the example of FIG. 7, the vertical RX antenna array distance (e.g., three distance units) is calculated according to the product of the vertical TX antenna array distance (e.g., one distance unit) and the TX antenna array staggering order (e.g., 3). In other words, distance element D1 of FIG. 4B may be calculated or set as a product of D2 of FIG. 4C and SO2.

As shown by the dashed lines in FIG. 7, the N1 antennas of the first (e.g., TX) antenna array and the N2 antennas of the second (e.g., RX) antenna array are adapted to create a virtual array. The virtual array may be shaped as a triangular lattice array, as commonly referred to in the art.

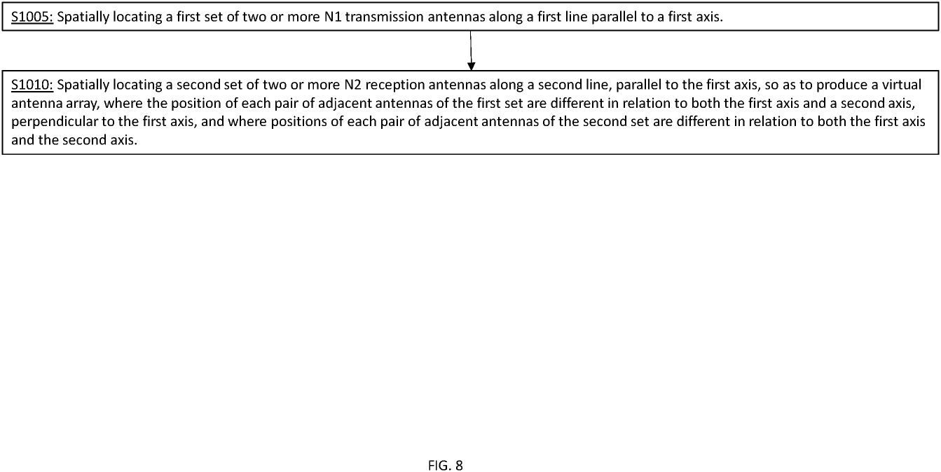

Reference is now made to FIG. 8 which is a flow diagram, depicting a method of producing a virtual antenna array, according to some embodiments of the invention.

As shown in step S1005, embodiments may include spatially locating a first set of two or more N1 transmission antennas along a first line parallel to a first axis. For example, as elaborated herein (e.g., in relation to FIG. 6), the N1 transmission antennas (schematically marked as ‘+’) may be spatially located along a line parallel to the X axis.

As shown in step S1010, embodiments may include spatially locating a second set of two or more N2 reception antennas along a second line, parallel to the first axis. For example, as elaborated herein (e.g., in relation to FIG. 6), the N2 reception antennas (schematically marked as ‘○’) may be spatially located along a second line parallel to the X axis. As elaborated herein (e.g., in relation to FIG. 6), this configuration may produce a virtual antenna array, including a plurality of virtual array elements (schematically marked as ‘⊕’).

It may be appreciated that the position of each pair of adjacent antennas of the first is different in relation to both the first axis (e.g., the X axis) and a second axis (e.g., the Y axis), perpendicular to the first axis, and the positions of each pair of adjacent antennas of the second set are different in relation to both the first axis (e.g., the X axis) and the second axis (e.g., the Y axis).

According to some embodiments, the position of each pair of adjacent antennas (e.g., antenna A1 and A2) of the first set of N1 antennas may be different in relation to both the first axis (e.g., the X axis) and a second axis (e.g., a Y axis), perpendicular to the first axis. Additionally, the positions of each pair of adjacent antennas (e.g., antenna B1 and B2) of the second set may be different in relation to both the first axis (e.g., the X axis) and a second axis (e.g., a Y axis). In other words, if position of adjacent antennas of the first antenna array is denoted by coordinates of perpendicular axes X and Y so: A1(X1, Y1), A2(X2, Y2), and position of adjacent antennas of the first antenna array is denoted by coordinates of perpendicular axes X and Y so: B1(X3, Y3) and B2(X4, Y4), then X1 is different from X2, Y1 is different from Y2, X3 is different from X4 and Y3 is different from Y4.

Embodiments of the invention may provide an improvement over technology of multiple antenna apparatuses (e.g., MIMO-based apparatuses), such as radars. For example, As elaborated herein, by carefully arranging the antenna elements, in antenna arrays of a multiple-antenna apparatus, embodiments of the invention may provide superior angular resolution in relation to comparable (as explained above) multiple antenna apparatuses.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. An apparatus comprising: a first antenna array; and a second antenna array, each antenna array comprising a of two or more antennas, wherein within each antenna array, the positions of each two adjacent antennas are different in relation to both a first axis and a second axis, perpendicular to the first axis.

2. The apparatus of claim 1, wherein the first antenna array and second antenna array are linear in respect to the first axis, and wherein the first antenna array and the second linear antenna array are staggered along the second axis, so as to provide an angular resolution that is superior to that of a comparable apparatus having the same number of antennas and requiring a substantially equal space, of which at least one of the first linear antenna array and second linear array is not staggered along the second axis.

3. The apparatus of claim 1, wherein the first antenna array comprises N1 antennas that are adapted to transmit RF energy, and wherein the second antenna array comprises N2 antennas that are adapted to receive a reflection of the transmitted RF energy.

4. The apparatus of claim 3, wherein the N1 antennas of the first antenna array are located along a first line parallel to the first axis, in a staggered array, and wherein the N2 antennas of the second antenna array are located along a second line parallel to the first axis in a staggered array.

5. The apparatus of claim 3, wherein the N1 antennas of the first antenna array are aligned in parallel along the first axis and placed at intervals of a first predefined distance (D1) along the second axis, according to a first staggering order (SO1).

6. The apparatus of claim 5, wherein the N2 antennas of the second antenna array are aligned in parallel along the first axis, and placed at intervals of the second distance (D2) along the second axis according to a second staggering order (SO2).

7. The apparatus of claim 6, wherein D2 is a product of D1 and SO1.

8. The apparatus of claim 6, wherein D1 is a product of D2 and SO2.

9. The apparatus of claim 6, wherein the N1 antennas of the first antenna array and the N2 antennas of the second antenna array are adapted to create a virtual array, shaped as a triangular lattice.

10. The apparatus of claim 6, wherein the N1 antennas of the first antenna array and the N2 antennas of the second antenna array are adapted to create a virtual antenna array that comprises:
a first number of virtual element positions along the first axis that is at least equal to (N1 + N2 - 1); and
a second number of virtual element positions along the second axis, that is at least equal to the product of SO1 and SO2.

11. The apparatus of claim 3 wherein the first antenna array is physically divided along the first axis to at least one first subset and at least one second subset.

12. The apparatus of claim 11 wherein a distance between the at least one first subset and the at least one second subset is equal to a width of the second antenna array.

13. The apparatus of claim 3 wherein the N1 antennas of the first antenna array are embedded in a first printed circuit board (PCB), and wherein the N2 antennas of the second antenna array are embedded in a second PCB.

14. A method of producing a virtual antenna array, the method comprising:
spatially locating a first set of two or more N1 transmission antennas along a first line parallel to a first axis; and
spatially locating a second set of two or more N2 reception antennas along a second line, parallel to the first axis, so as to produce a virtual antenna array, wherein the position of each pair of adjacent antennas of the first set are different in relation to both the first axis and a second axis, perpendicular to the first axis, and wherein positions of each pair of adjacent antennas of the second set are different in relation to both the first axis and the second axis.

15. The method of claim 14, further comprising:
locating the first set of antennas at a first staggered, linear array along the first axis, according to a first staggering order (SO1); and
locating the second set of antennas at a second staggered, linear array along the second axis, according to a second staggering order (SO2), wherein SO1 and SO2 are larger than 1.

16. The method of claim 15, wherein the virtual antenna array comprises:
a first number of virtual element positions along the first axis that is at least equal to a (N1 + N2 - 1); and
a second number of virtual element positions along the second axis, that is at least equal to the product of SO1 and SO2.

17. The method of claim 14, wherein the virtual antenna array is a virtual MIMO antenna array shaped as a triangular lattice array.

18. The method of claim 14, further comprising:
embedding the first set of N1 antennas in a PCB; and
embedding the second set of N2 antennas in a PCB.

19. An antenna array comprising:
a first staggered array of N1 antennas, embedded in a PCB and adapted to transmit an RF signal; and
a second staggered array of N2 antennas, embedded in a PCB and adapted to receive a reflection of the RF signal,
wherein the N1 antennas of the first array are aligned along a first axis and placed at intervals of a first predefined distance (D1) along a second axis, perpendicular to the first axis, and wherein the N2 antennas of the second array are aligned along a line parallel to the first axis, and placed at intervals of a second distance (D2) along the second axis.

20. The antenna array of claim 19, wherein the N1 antennas of the first array are placed at intervals of distance D1 along the second axis according to a first staggering order (SO1), and wherein the N2 antennas of the second array are placed at intervals of distance D2 along the second axis according to a second staggering order (SO2), and wherein D2 is set as a product of D1 and SO1.

21. The antenna array of claim 19, wherein the N1 antennas of the first array are placed at intervals of distance D1 along the second axis according to a first staggering order (SO1), and wherein the N2 antennas of the second array are placed at intervals of distance D2 along the second axis according to a second staggering order (SO2), and wherein D1 is a product of D2 and SO2.

22. The antenna array of claim 19 wherein the first array of N1 antennas is physically divided along the first axis to at least one first subset and at least one second subset, and wherein a distance between the at least one first subset and the at least one second subset is equal to a dimension of the second array of N2 antennas.
